(19) United States
(12) Patent Application Publication
(10) Pub. No.: US 2015/0341569 A1
(43) Pub. Date: Nov. 26, 2015

(54) IMAGE SWITCHING APPARATUS, IMAGE SWITCHING SYSTEM, AND IMAGE SWITCHING METHOD

(71) Applicant: Panasonic Intellectual Property Management Co., Ltd., Osaka (JP)

(72) Inventors: Takeshi Takita, Fukuoka (JP); Kenji Kobayashi, Fukuoka (JP)

(21) Appl. No.: 14/711,692

(22) Filed: May 13, 2015

(30) Foreign Application Priority Data
May 23, 2014 (JP) 2014-107298

(51) Int. Cl. H04N 5/268; G06K 9/00; G06T 5/00; G06T 7/20; G06K 9/46; H04N 5/232

(52) U.S. Cl. CPC H04N 5/268; G06K 9/46; H04N 5/23238; G06T 5/001; G06T 7/2033; G06K 9/00228

(57) ABSTRACT

Provided is an image switching apparatus that is capable of improving utilization efficiency of features of images in switching image display, by including: a data acquisition unit configured to acquire data that includes images captured by imaging devices; a feature amount detection unit configured to detect feature amounts of the acquired data; a designation unit configured to designate a continuous display time in a case of displaying the images corresponding to the data, the feature amounts of which are detected, on a display device based on the feature amounts of the data; and an image display control unit configured to switch and display the respective images on the display device for each designated continuous display time.

### BACKGROUND OF THE INVENTION

1. Field of the Invention

The present invention relates to an image switching apparatus, an image switching system, and an image switching method.

2. Description of the Related Art

In the related art, a monitor camera apparatus configured to switch and display a plurality of images that are captured by a plurality of imaging devices is known. According to a monitor camera apparatus disclosed in Japanese Patent Unexamined Publication No. 5-035993, for example, if a value of a difference between an image that was captured at this time and another image that was previously captured by the same monitor camera does not exceed a predetermined value, display of the image that was captured at this time is skipped.

According to the monitor camera apparatus disclosed in the above literature, the determination regarding whether or not to display an image at the time of switching an image is made based on whether or not the difference between two continuous images exceeds a specific value. In such a case, if there is no variation in the two continuous images even when a characteristic portion is included in the image that was previously captured, the characteristic portion is excluded from being a target of monitoring. Since a lot of feature amounts (the number of persons, for example), to which attention is to be paid, are included in the image that was captured by an imaging device, there is a problem in that a display method based on features of the image is not sufficiently utilized in switching of the image based on the difference between the two continuous images.

The present invention was made in view of the above circumstances and is designed to provide an image switching apparatus, an image switching system, and an image switching method capable of improving utilization efficiency of features of an image in switching image display.

### SUMMARY OF THE INVENTION

According to the present invention, there is provided an image switching apparatus including: a data acquisition unit configured to acquire data that includes images captured by imaging devices; a feature amount detection unit configured to detect feature amounts of the acquired data; a designation unit configured to designate a continuous display time in a case of displaying the images corresponding to the data, the feature amounts of which are detected, on a display device based on the feature amounts of the data; and an image display control unit configured to switch and display the respective images on the display device for each designated continuous display time.

According to the present invention, there is provided an image switching system in which an imaging device, a display device, and an image switching apparatus are connected via a network, wherein the imaging device includes an imaging unit configured to capture images and a first communication unit configured to transmit data including the captured images, wherein the image switching apparatus includes a second communication unit configured to receive the data from the imaging device, a feature amount detection unit configured to detect feature amounts of the received data, a designation unit configured to designate a continuous display time in a case of displaying the images corresponding to data, the feature amounts of which are detected, on the display device based on the feature amounts of the data, and an image display control unit configured to switch and display the respective images on the display device for each designated continuous display time, wherein the second communication unit transmits, to the display device, the images and control data for switching and displaying the respective images on the display device for each designated continuous display time, and wherein the display device includes a third communication unit configured to receive the images and the control data and a display unit configured to switch and display the respective images for each designated continuous display time based on the control data.

According to the present invention, there is provided an image switching method for an image switching apparatus, the method including: acquiring data including images that are captured by an imaging device; detecting feature amounts of the acquired data; designating a continuous display time in a case of displaying the images corresponding to the data, the feature amounts of which are detected, on a display device based on the feature amounts of the data; and switching and displaying the respective images on the display device for each designated continuous display time.

According to the present invention, it is possible to improve utilization efficiency of feature amounts of an image in switching image display.

### BRIEF DESCRIPTION OF DRAWINGS

FIG. 1 is a block diagram showing a configuration example of an image switching system according to a first exemplary embodiment;

FIG. 2A is a block diagram showing a configuration example of an imaging device according to the first exemplary embodiment;

FIG. 2B is a block diagram showing a configuration example of a display device according to the first exemplary embodiment;

FIG. 3 is a flow diagram showing an operation example of an output image configuration unit according to the first exemplary embodiment;

FIG. 4A is a diagram schematically showing a first example of a relationship between an image layout pattern and a total sequence switching time according to the first exemplary embodiment;

FIG. 4B is a diagram schematically showing the first example of the relationship between the image layout pattern and the total sequence switching time according to the first exemplary embodiment;

FIGS. 5A and 5B schematically show a second example of the relationship between the image layout pattern and the total sequence switching time according to the first exemplary embodiment;

FIG. 6A is a diagram schematically showing a third example of the relationship between the image layout pattern and the total sequence switching time according to the first exemplary embodiment;

FIG. 6B is a diagram schematically showing the third example of the relationship between the image layout pattern and the total sequence switching time according to the first exemplary embodiment;

FIG. 7 is a block diagram showing a configuration example of an image switching system according to a second exemplary embodiment;

FIG. 8A is a flow diagram showing an operation example of an image correction unit according to the second exemplary embodiment;

FIG. 8B is a flow diagram showing the operation example of the image correction unit according to the second exemplary embodiment;

FIG. 9 is a block diagram showing a configuration example of an image switching system according to a third exemplary embodiment;

FIG. 10 is a flow diagram showing an operation example of an image correction unit according to the third exemplary embodiment;

FIG. 11A is a diagram schematically showing an example of a relationship between an image layout pattern and a total sequence switching time according to the third exemplary embodiment;

FIG. 11B is a diagram schematically showing the example of the relationship between the image layout pattern and the total sequence switching time according to the third exemplary embodiment;

FIG. 12 is a block diagram showing a configuration example of an image switching system according to a fourth exemplary embodiment;

FIG. 13A is a diagram schematically showing an example of a relationship between an image layout pattern and a total sequence switching time according to a fourth exemplary embodiment; and

FIG. 13B is a diagram schematically showing the example of the relationship between the image layout pattern and the total sequence switching time according to the fourth exemplary embodiment.

### DETAILED DESCRIPTION OF THE PREFERRED EMBODIMENTS

Hereinafter, a description will be given of exemplary embodiments of the present invention with reference to drawings.

### First Exemplary Embodiment

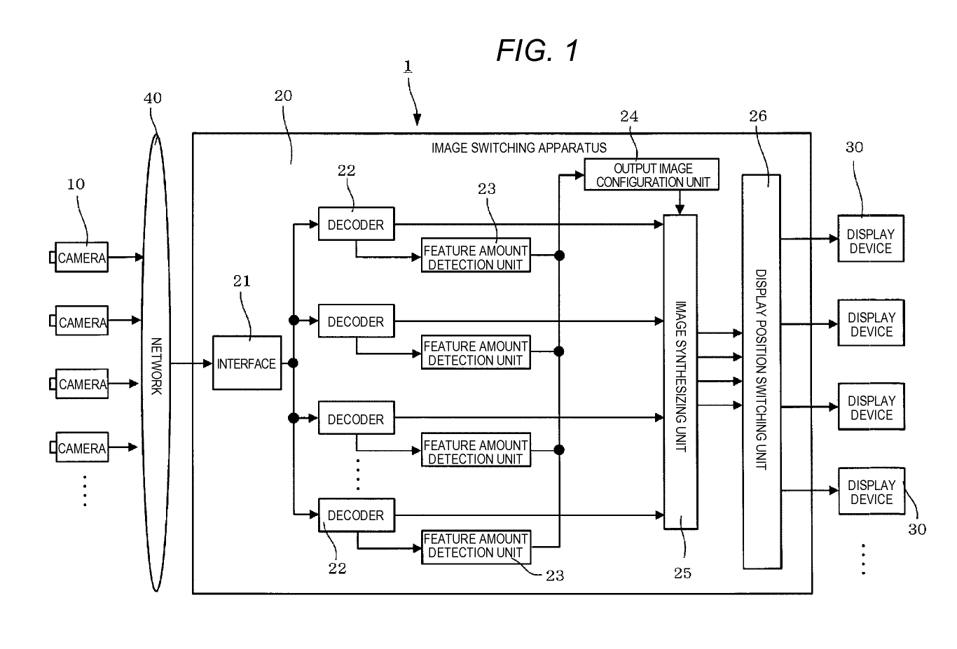

FIG. 1 is a block diagram showing a configuration example of image switching system 1 according to a first exemplary embodiment. Image switching system 1 includes imaging device (camera) 10, image switching apparatus 20, and display device 30. Imaging device 10, image switching apparatus 20, and display device 30 are connected to each other via network 40. Network 40 includes the Internet, a wired Local Area Network (LAN), or a wireless LAN (for example, Wireless Fidelity (Wi-Fi)), for example. One display device 30 may be included in image switching apparatus 20.

Imaging device 10 captures an image of a predetermined area and acquires image data. The image includes a moving image, a video, and a stationary image, for example. Imaging device 10 may collect sound and acquire sound data. Usage of imaging device 10 enables real-time monitoring to be performed. A plurality of imaging devices 10 may be provided, and respective imaging devices 10 may acquire a plurality of image data items. Alternatively, one imaging device 10 may acquire a plurality of images of different areas. Alternatively, these configurations may be combined.

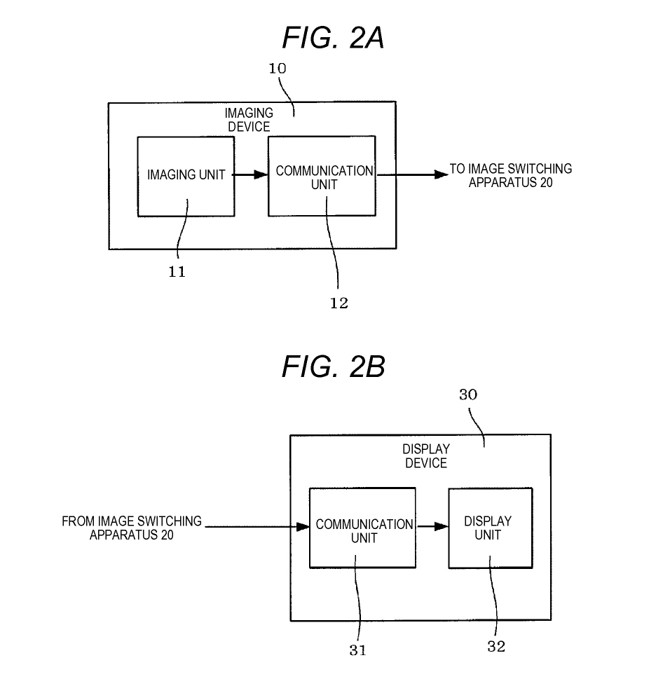

FIG. 2A is a block diagram showing a configuration example of imaging device 10. Imaging device 10 includes imaging unit 11 configured to capture an image and communication unit 12 configured to transmit data that includes the captured image data. Communication unit 12 is an example of the first communication unit. Imaging device 10 may be provided with a sound collection unit (not shown) configured to collect ambient sound. The sound includes various kinds of sound. Data that is transmitted by communication unit 12 may include the sound data collected by the sound collection unit.

In FIG. 1, image switching apparatus 20 includes interface 21, decoder 22, feature amount detection unit 23, output image configuration unit 24, image synthesizing unit 25, and display position switching unit 26, for example. Image switching apparatus 20 includes a Central Processing Unit (CPU), a Read Only Memory (ROM), or a Random Access Memory (RAM) which is not shown in the drawing, for example. In image switching apparatus 20, the CPU, for example, executes a program that is stored on the ROM to realize the respective functions of image switching apparatus 20.

Interface 21 is an interface for communicating various data items via network 40. Interface 21 receives the data from imaging device 10 via network 40. The data from imaging device 10 includes at least image data and may also include sound data. Interface 21 is an example of the data acquisition unit and the second communication unit.

Decoder 22 decodes coded (subjected to data compression or encrypted, for example) image data and derives a decoded image therefrom. Decoder 22 may decode sound data and derive decoded sound. For example, a plurality of decoders 22 are provided. Decoder 22 is an example of the decoded image deriving unit.

Feature amount detection unit 23 detects feature amounts of decoded data (for example, a decoded image or decoded sound). Feature amount detection unit 23 performs predetermined image recognition processing on the decoded image and specifies features of the image (for example, a person or a face of a person), for example. Feature amount detection unit 23 performs predetermined sound recognition processing on the decoded sound and specifies features of the sound (for example, a sound of a person, an abnormal sound, or a predetermined keyword), for example.

The feature amounts of the image include the number of persons included in the decoded image, presence or absence or the amount of motion of a person included in the decoded image, the number of detected faces that are included in the decoded image, and presence or absence of a predetermined face that is included in the decoded image, for example. The presence or absence of the predetermined face is determined based on whether or not a face that is registered in advance in a database (not shown) has been detected in the decoded image. The presence or absence of motion is detected by a Video Motion Detector (VMD), for example. The VMD is included in feature amount detection unit 23.

The feature amount of sound includes the presence or absence of abnormal sound included in the decoded sound, presence or absence of a predetermined keyword that is included in the decoded sound or presence or absence of sound that is included in the decoded sound and is equal to or greater than a predetermined signal level, and presence or absence of sound of a predetermined person that is included in the decoded sound, for example. The presence or absence of a predetermined keyword is determined based on whether or not a keyword that is registered in advance in a database (not shown) has been detected in the decoded sound, for example. The presence or absence of sound of a predetermined person is determined based on whether or not a pattern of a sound of a person, which is registered in advance in a database (not shown), to which attention is to be paid, coincides with a pattern of the decoded sound. The person to which attention is to be paid includes a person who is registered in a black list and is a Very Important Person (VIP).

Output image configuration unit 24 designates a continuous display time in a case of displaying a decoded image on display device 30, based on the feature amounts of the decoded image, for example. Output image configuration unit 24 designates a continuous display time in a case of displaying a decoded image corresponding to decoded sound on display device 30, based on the feature amounts of the decoded sound, for example.

For example, the decoded sound and the decoded image are associated based on a degree of coincidence between a time at which the sound data was collected and a time at which the image data was captured. If the time at which the sound was collected coincides with the time at which the image was captured, decoded sound based on the sound collected at the time at which the sound was collected corresponds to the decoded image based on the image captured at the time at which the image data was captured.

Output image configuration unit 24 designates an image layout pattern for displaying the decoded image based on feature amounts of data (including an image or sound), for example. The image layout pattern includes an arrangement position (display position) of each decoded image corresponding to a screen of display device 30 and a continuous display time of each decoded image, for example.

Output image configuration unit 24 designates the image layout pattern based on the number of decoded images, the feature amount which are detected, a minimum display time, and total sequence switching time T. The minimum display time is the shortest time during which the decoded images with detected feature amounts are displayed, and corresponds to two seconds, for example. Total sequence switching time T is an example of the image switching cycle corresponding to a cycle by which the images are switched and displayed, and corresponds to ten seconds, for example. In such a case, if the number of decoded images, the feature amount of which are detected, is four, for example, a single-image layout pattern as will be described later is designated. If the number of decoded images, the feature amounts of which are detected, is five, a multiple-image layout pattern as will be described later is designated. The decoded images, the feature amount of which are detected, include decoded images corresponding to decoded sound, the feature amount of which is detected.

As described above, output image configuration unit 24 is an example of the designation unit configured to designate a continuous display time and an image layout pattern.

Image synthesizing unit 25 synthesizes a plurality of decoded images in such a format that display device 30 can output the decoded images, based on the image layout pattern (the arrangement of each image and a display time of each image, for example) that is designated by output image configuration unit 24, for example.

Display position switching unit 26 performs control so as to switch the decoded images to be displayed on display device 30 as a display position. Display position switching unit 26 switches and displays the decoded images on display device 30 for each continuous display time based on the image layout pattern, for example. Display position switching unit 26 is an example of the image display control unit. An upper-order application layer decides which of the decoded images is to be displayed on which of display devices 30. For example, a decoded image displayed on a display device at a monitoring center can be different from a decoded image displayed on a display device that is installed at an entrance of a store.

FIG. 2B is a block diagram showing a configuration example of display device 30. Display device 30 includes communication unit 31 and display unit 32. Communication unit 31 receives various data items, and for example, receives decoded images from image switching apparatus 20 and a control signal for switching and displaying the respective decoded images, for example. Display unit 32 displays various data items. Display unit 32 switches and displays the respective decoded images for each continuous display time that is designated by image switching apparatus 20, based on the received control signal, for example.

A plurality of display devices 30 may be provided. For example, one of the plurality of display devices 30 provided may be arranged as a main monitor in a monitoring center while other display devices 30 may be arranged as sub monitors in front of or inside stores. Respective display devices 30 may display the same decoded image or different decoded images. That is, respective display devices 30 may perform display in accordance with the same image layout pattern or different image layout patterns.

As described above, display devices 30 may be installed in a monitoring center, a monitoring room, or a security office, near a cash register, in front of a store, or at an entrance of a store. Display devices 30 may be installed for the purpose of improving security in a predetermined area or for the purpose of calling for or drawing the attention of customers.

Next, a description will be given of an operation example of output image configuration unit 24 in image switching apparatus 20.

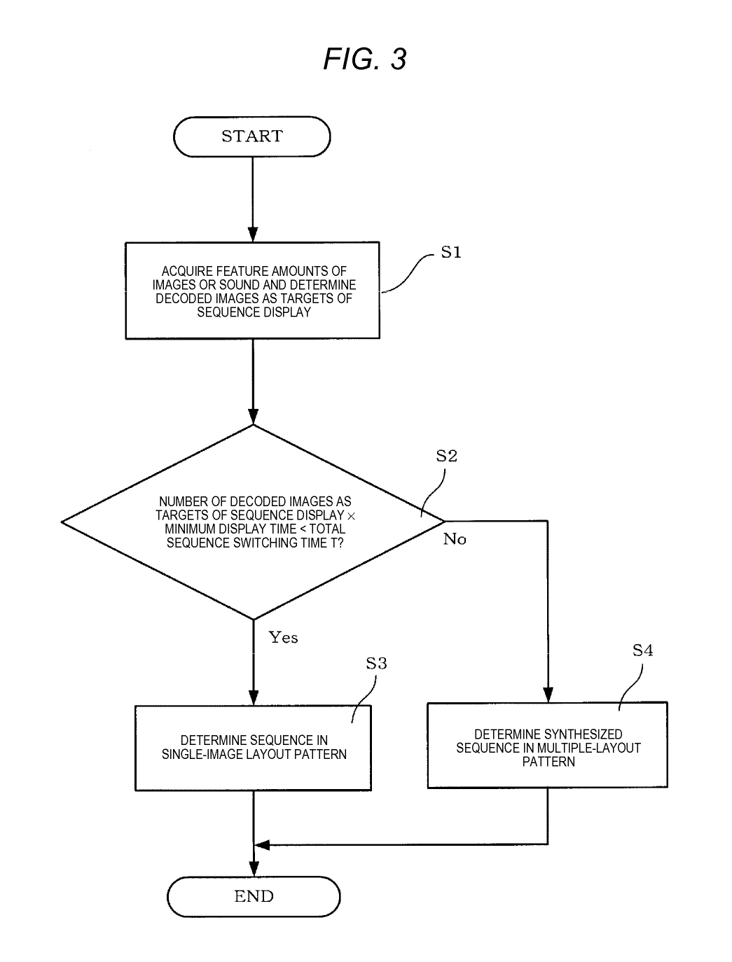

FIG. 3 is a flowchart showing an operation example of output image configuration unit 24 in image switching apparatus 20.

First, feature amount detection unit 23 detects feature amounts of the respective images (the respective decoded images) or the respective sound (the respective decoded sound) that are acquired from respective imaging devices 10. Output image configuration unit 24 determines camera images (movies) as targets of sequence display (sequential display) based on the detected feature amounts (S1).

In the sequence display, decoded images, features of which are detected, may be regarded as targets of the display while decoded images, features of which are not detected, may not be regarded as targets of the display. In the sequence display, a continuous display time may be set to be longer for a decoded image with greater feature amounts while the continuous display time may be set to be shorter for a decoded image with less feature amounts. The sequence display is performed in accordance with an image layout pattern.

Output image configuration unit 24 may determine an image layout pattern such that a decoded image including more persons is displayed with higher priority on display device 30, in accordance with the number of persons detected as a feature amount, for example. To display the decoded image with higher priority includes setting a longer continuous display time, for example (the same is true in the following description).

Output image configuration unit 24 may determine an image layout pattern such that a decoded image which includes motion or a large amount of movement is to be displayed with higher priority on display device 30, in accordance with the presence or absence of motion or the amount of movement of a person detected as a feature amount, for example.

Output image configuration unit 24 may determine an image layout pattern such that a decoded image from which a larger number of faces are detected is to be displayed with higher priority on display device 30, in accordance with the number of faces detected as a feature amount, for example.

Output image configuration unit 24 may determine an image layout pattern such that a decoded image which includes a person registered in a black list is to be displayed on display device 30 in a case in which the person registered in the black list is detected by facial recognition, for example.

The black list may be held in a memory, which is not shown in the drawing, in image switching apparatus 20. The black list may be held in an external server and may be referred to by output image configuration unit 24 via network 40.

Output image configuration unit 24 may determine an image layout pattern such that a decoded image which includes a VIP is to be displayed with higher priority on display device 30 in a case in which a person registered in a VIP list is detected by facial recognition, for example.

The VIP list may be held in a memory, which is not shown in the drawing, in image switching apparatus 20. The VIP list may be held in an external server and may be referred to by output image configuration unit 24 via network 40.

Output image configuration unit 24 may determine an image layout pattern such that a decoded image corresponding to an abnormal sound is to be displayed with higher priority on display device 30 in a case in which abnormal sound is detected as a feature amount, for example. Patterns of abnormal sound may be registered in advance, or sound with predetermined waveforms may be registered in advance to be compared with detected abnormal sound, for example.

Output image configuration unit 24 may determine an image layout pattern such that a decoded image corresponding to a large sound is to be displayed with higher priority on display device 30 in a case in which a large sound that is equal to or greater than a predetermined signal level is detected as a feature amount, for example.

Output image configuration unit 24 determine an image layout pattern such that a decoded image corresponding to sound which includes a keyword is to be displayed with higher priority on display device 30 in a case in which the predetermined keyword that is registered in advance as a feature amount is detected, for example.

Next, output image configuration unit 24 determines whether or not a result of multiplying the number of camera images as targets of the sequence display by the minimum display time is smaller than total sequence switching time T (S2). Total sequence switching time T is a time required for displaying one entire sequence and is an example of the image switching cycle. The minimum display time is a time, during which one decoded image is displayed, in the total sequence switching time. Total sequence switching time T and the minimum display time are arbitrarily set via an operation unit (not shown), for example.

If the result of multiplication in S2 is smaller than total sequence switching time T, output image configuration unit 24 designates a single-image layout pattern as the image layout pattern (S3). The single-image layout pattern is a layout pattern in which a single decoded image is displayed in each time zone in total sequence switching time T. Output image configuration unit 24 designates a continuous display time based on the feature amount of each decoded image and total sequence switching time T, for example, in the case of the single-image layout pattern. Image synthesizing unit 25 assembles each decoded image that is selected in S1 in the single-image layout pattern, assembles information about the continuous display time of the decoded image on each screen, and determines a sequence to be displayed on display device 30.

In contrast, if the result of multiplication in S2 is equal to or greater than total sequence switching time T, output image configuration unit 24 designates a multiple-image layout pattern as the image layout pattern. Sequence display to be synthesized is determined (S4). The multiple-image layout pattern is a layout pattern in which a plurality of images are displayed in the respective time zones. Output image configuration unit 24 designates a continuous display time based on the number of decoded images to be displayed on a single screen (four or eight, for example), total feature amounts of decoded images to be displayed on a single screen, and total sequence switching time T, for example, in the case of the multiple-image layout pattern. Image synthesizing unit 25 assembles the respective decoded images selected in S1 in the multiple-image layout pattern, assembles information about the continuous display time of the decoded images in each screen, and determines a sequence to be displayed on display device 30.

Through the processing shown in FIG. 3, image switching apparatus 20 can determine an image layout pattern based on the feature amounts of the data (image data or sound data, for example) that is acquired by image device 10. Image switching apparatus 20 can determine a time, during which the respective images as targets of the display are continuously displayed, based on the feature amounts of the data (image data or sound data, for example) that is acquired by imaging device 10. Accordingly, it is possible for a person who is in charge of monitoring to monitor an image to be monitored with higher priority and to improve monitoring accuracy, for example. It is possible to display a characteristic image (an area where a large number of people are present in a store, for example) with higher priority for customers and to give, to the customers, an impression that there are many customers in the store. Therefore, it is possible to improve sales promotion efficiency and to efficiently perform marketing.

Next, a description will be given of a relationship between an image layout pattern and total sequence switching time T.

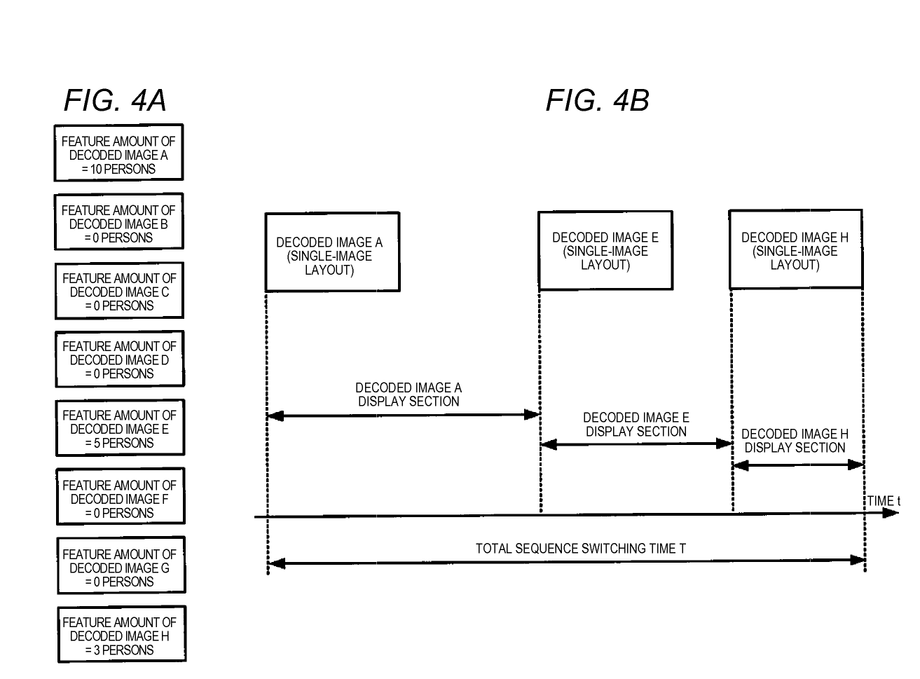

FIGS. 4A and 4B are diagrams schematically showing a first example of a relationship between an image layout pattern and total sequence switching time T. In FIGS. 4A and 4B, a case in which the image layout pattern is a single-image layout is shown.

In FIG. 4A, images (decoded images A to H) obtained by decoding images from each imaging device 10 and feature amounts detected from the decoded images are shown in the vertical direction. In FIGS. 4A and 4B, the number of persons included in the images is employed as the feature amount.

In FIG. 4B, an image layout pattern, a continuous display time (also referred to as a display section) of each of the decoded images A, E, and H, and total sequence switching time T in the case of FIG. 4A are shown. Output image configuration unit 24 determines a length of each display section in accordance with (for example, in proportion to) how large the detected feature amount is (how large the number of persons are), for example.

Although the layouts of the decoded images A, E, and H are shorter than the display sections in FIG. 4B, the images are displayed from start points to end points of the display sections in practice. Total sequence switching time T corresponds to a total amount of time that the display sections of respective decoded images A, E, and H are shown for.

In the decoded image A, for example, the number of persons included in the image as a feature amount is ten. In the decoded image E, the number of persons included in the image as a feature amount is five. In the decoded image H, the number of persons included in the image as a feature amount is three. In the decoded images B, C, D, F, and G, the number of persons included in the images as feature amounts is zero, and therefore, the decoded images B, C, D, F, and G are not targets of sequence display.

In FIGS. 4A and 4B, output image configuration unit 24 derives the lengths of the display sections of the respective decoded images based on total sequence switching time T and the feature amounts included in respective decoded images A, E, and H, for example. In FIGS. 4A and 4B, the display section of the decoded image A is T×( 10/18) (seconds), the display section of the decoded image E is T×( 5/18) (seconds), and the display section of the decoded image H is T×( 3/18) (seconds).

According to the sequence of the image layout pattern shown in FIGS. 4A and 4B, if the number of decoded images, the feature amounts of which are detected, is small, it is possible to display a single decoded image on a single screen and to facilitate checking of a state of an area where the decoded image is captured. Therefore, the person who is in charge of monitoring can easily monitor the monitored area.

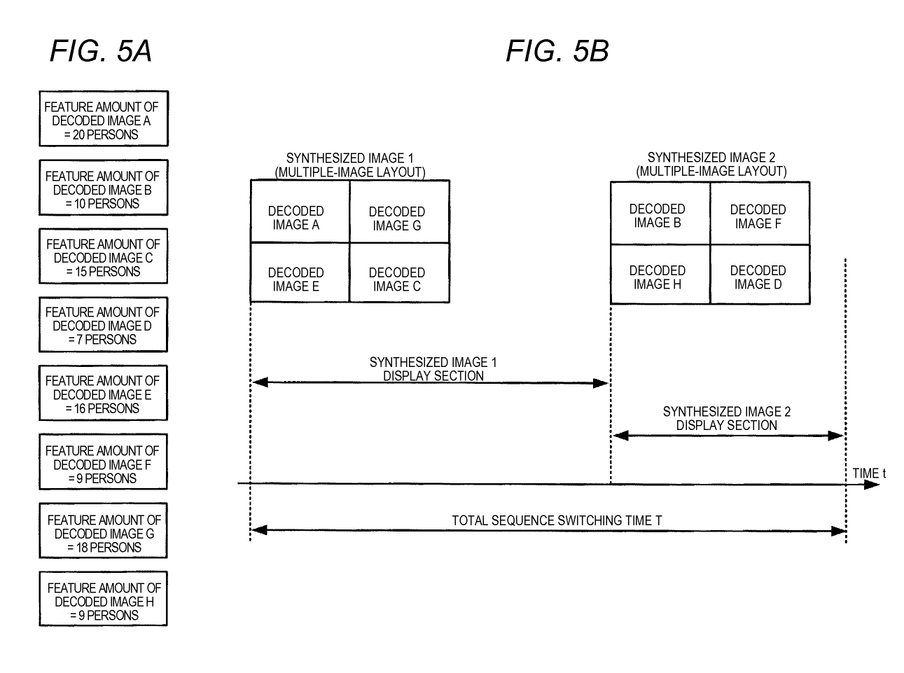

FIGS. 5A and 5B schematically show a second example of a relationship between an image layout pattern and total sequence switching time T. In FIG. 5, an example in which an image layout pattern is a multiple-image layout is shown. In FIG. 5, an example of a multiple-image layout is shown in which four images with the same size are displayed on display unit 32 in a single display device 30.

Although the layouts of synthesized images 1 and 2 are shorter than the display sections in FIG. 5, synthesized images 1 and 2 are displayed from start points to end points of the display sections in practice. Total sequence switching time T corresponds to a total amount of time that the display sections of respective synthesized images 1 and 2 are shown for.

In the decoded image A, for example, the number of persons included in the image as a feature amount is twenty. In the same manner, a plurality of persons are included in the decoded images B to H. When the four images are aligned in order from the largest feature amount to the smallest, twenty persons are detected in the decoded image A, eighteen persons are detected in the decoded image G, sixteen persons are detected in the decoded image E, and fifteen persons are detected in the decoded image C. The decoded images A, G, E, and C are displayed as synthesized image 1 while a single screen of display device 30 is equally divided into four sections.

If four other images are aligned in the order from the largest feature amount after decoded images A, G, E, and C, ten persons are detected in decoded image B, nine persons are detected in decoded image F, nine persons are detected in decoded image H, and seven persons are detected in decoded image D. Decoded images B, F, H, and D are displayed as synthesized image 2 while a single screen of display device 30 is equally divided into four sections.

Since the feature amounts in synthesized image 1 are larger than those in synthesized image 2, the display section of synthesized image 1 is larger than the display section of synthesized image 2 in total sequence switching time T. In FIG. 5, output image configuration unit 24 derives the length of the display sections of the respective synthesized images based on total sequence switching time T and the feature amounts included in respective synthesized images 1 and 2, for example. Output image configuration unit 24 calculates the lengths of the display sections of the respective synthesized images based on ratios of total feature amounts included in the synthesized images with respect to total sequence switching time T, for example. In FIG. 5, the display section of the synthesized image 1 is T×( 69/104) (seconds), and the display section of the synthesized image 2 is T×( 35/104) (seconds), for example.

According to the sequence of the image layout pattern shown in FIG. 5, it is possible to check an image of an area including a larger feature amount with higher priority. It is possible to check images of a plurality of areas at the same time and to thereby improve monitoring efficiency. In terms of marketing, it is possible to quickly determine an area where popular merchandise is present, for example, by comparing other areas and to enable customers to efficiently walk around in the store.

The arrangement positions of the respective decoded images in the multiple-image layout shown in FIG. 5 is an example, and the respective decoded images may be arranged at other positions as long as the positions are based on the feature amounts of the data.

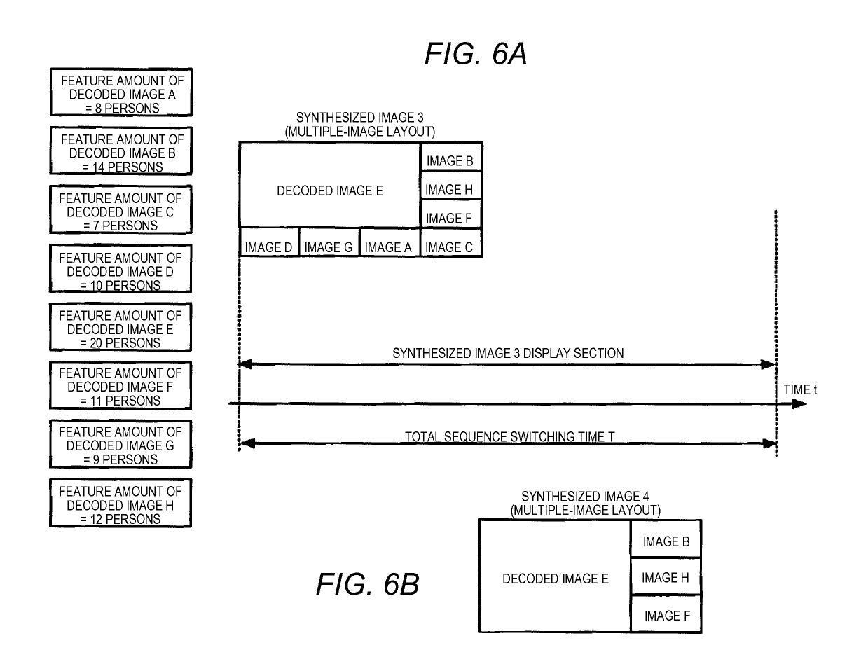

FIG. 6A is a diagram schematically showing a third example of a relationship between an image layout pattern and total sequence switching time T. In FIG. 6A, a case in which an image layout pattern is a multiple-image layout is shown. FIG. 6A shows an example in which a single image is displayed to have a larger size than the other images on display unit 32 in a single display device 30 while the other images are displayed to have an equal small size.

Although the layout of synthesized image 3 is shorter than the display section in FIG. 6A, synthesized image 3 is displayed from the start point to the end point of the display section in practice. Total sequence switching time T corresponds to a continuous display time of the synthesized image 3. FIG. 6A shows an example in which display is not switched.

In decoded image A, for example, the number of persons included in the image as a feature amount is eight. In the same manner, a plurality of persons are included in decoded images B to H. In the order from the largest feature amount to the smallest, twenty persons are detected in decoded image E, fourteen persons are detected in decoded image B, twelve persons are detected in decoded image H, eleven persons are detected in decoded image F, ten persons are detected in decoded image D, nine persons are detected in decoded image G, eight persons are detected in decoded image A, and seven persons are detected in decoded image C.

In FIG. 6A, decoded image E including the largest feature amount is displayed in the largest display region, and the other decoded images A to D and F to H are aligned around decoded image E (in a display region adjacent to a side or a bottom thereof, for example).

According to the sequence of the image layout pattern shown in FIG. 6A, it is possible to check the image of the area including the larger feature amount with higher priority. It is possible to check the images of the plurality of areas at the same time and to thereby improve monitoring efficiency. In terms of marketing, it is possible to quickly determine an area where popular merchandise is present, for example, by comparing other areas and to enable customers to efficiently walk around in the store.

Although FIG. 6A shows the example of the multiple-image layout including eight display regions as synthesized image 3, synthesized image 4 including four regions may be employed as shown in FIG. 6B. In synthesized image 4, decoded image E including the largest feature amount is displayed in the largest display region, and the other decoded images B, H, and F are aligned around decoded image E (in a display region adjacent to a side thereof, for example).

Which of eight screens as in synthesized image 3 and four screens as in synthesized image 4 are to be employed may be set in advance, or alternatively, a screen including a minimum number of displays to be shown at the same time may be selected. For example, output image configuration unit 24 may select the multiple layout similar to that in synthesized image 4 if there are three decoded images, the feature amounts of which are present, and select the multiple layout similar to that in synthesized image 3 if there are six decoded images, the feature amounts of which are present.

The arrangement positions of the respective decoded images in the multiple-image layouts shown in FIGS. 6A and 6B are examples, and the respective decoded images may be arranged at different positions as long as the positions are based on the feature amounts of the data.

Output image configuration unit 24 may periodically determine the image layout pattern before the start or after the completion of total sequence switching time T, for example. If the order of the feature amounts of the respective decoded images changes, output image configuration unit 24 changes positions, at which the respective decoded images are allocated, in the respective display regions in the image layout pattern in accordance with the feature amounts, for example.

Although FIGS. 4A to 6B show the examples in which the numbers of persons included in the decoded images are employed as the feature amounts, other feature amounts (motion of a person or the amount of movement, for example) may be employed. Output image configuration unit 24 may use a plurality of feature amounts (the number of persons and presence or absence of motion, for example) to determine an image layout pattern and determine a sequence. Weighting of the respective feature amounts (for example, the number of persons to which the amount of movement or a face detection result is to be considered to correspond) may arbitrarily set and held.

According to image switching apparatus 20, it is not necessary to determine in advance and register in advance which of decoded images is to be displayed on which of display devices 30, at which timing the images are to be switched, and what kind of image layout is to be employed.

According to image switching apparatus 20, it is possible to cause customers and the like to recognize that a front of a store and an entrance of a store is a monitored area by installing display device 30 configured to display images based on feature amounts in front of the store or at the entrance of the store, for example. By displaying an area with the larger feature amount with the higher priority, an area where a large number of persons are present is displayed with priority, for example. With such a configuration, it is possible to cause customers to notice the fact that there are many customers in the store, for example, and to thereby improve marketing efficiency.

In addition, it is possible to easily specify an image with the larger feature amount, that is, an imaged area including the larger feature amount. For this reason, it is possible to recognize in which monitored areas a characteristic event is occurring and to thereby improve monitoring efficiency.

As described above, it is possible to improve utilization efficiency of feature amounts of images in switching image display and to improve monitoring efficiency and marketing efficiency.

Since decoded images, the feature amounts of which are present, are selected and displayed, it is possible to reduce synthesis burden on image synthesizing unit 25 and display burden on display device 30. Accordingly, image switching apparatus 20 makes it possible to display more naturally and smoothly display decoded images without causing a decrease in frame rate.

In the case of detecting feature amounts from decoded images, it is possible to omit a sound collecting function in imaging device 10 and to thereby simplify imaging device 10.

In the case of detecting feature amounts from decoded sound, if a characteristic event (abnormal sound large sound, for example) relating to sound occurs even when large characteristic changes are not found in decoded images, it is possible to display the image of the area where the sound occurs with priority. Therefore, it is possible to enhance security.

### Second Exemplary Embodiment

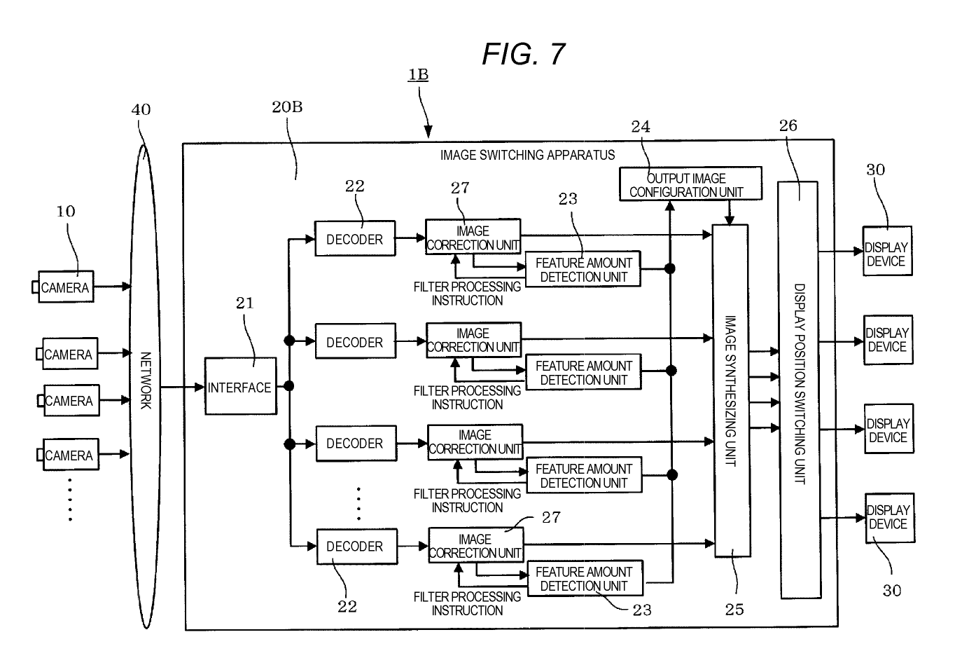

FIG. 7 is a block diagram showing a configuration example of image switching system 1B according to a second exemplary embodiment. Image switching system 1B includes imaging device 10, image switching apparatus 20B, and display device 30. In image switching system 1B in FIG. 7, the same reference numerals are given to the same configurations as those in image switching system 1 in FIG. 1, and descriptions thereof will be omitted or briefly given.

Image switching apparatus 20B in FIG. 7 includes image correction unit 27 unlike image switching apparatus 20 in FIG. 1. Each image correction unit 27 is provided in a stage after decoder 22, performs image correction on input data, and sends decoded images after correction to image synthesizing unit 25 and feature amount detection unit 23. Image correction unit 27 is an example of the first image correction unit.

In this exemplary embodiment, an example in which presence or absence of a predetermined face (face recognition) is employed as a feature amount is shown. Image correction unit 27 corrects decoded images in accordance with feature amounts detected by feature amount detection unit 23, for example. That is, if feature amounts are detected by feature amount detection unit 23, image correction unit 27 receives an instruction for image correction (instruction for filter processing) through a feedback from feature amount detection unit 23. If a predetermined face is detected in a decoded image, for example, image correction unit 27 reduces a resolution of the decoded image to defocus the decoded image or increase the resolution of the decoded image in order to clearly show the decoded image.

Next, a description will be given of an operation example of image correction unit 27.

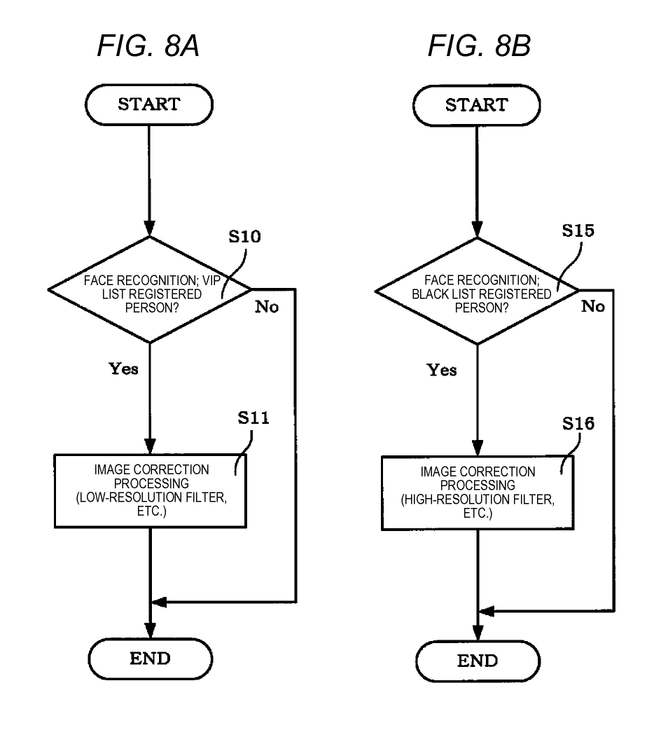

FIG. 8A is a flowchart showing a first operation example of image correction unit 27. FIG. 8A shows an operation example in a case in which a person who is registered in a VIP list is detected.

Feature amount detection unit 23 matches a face of a person included in a decoded image with a face of a person registered in advance in the VIP list, for example, and determines whether or not the face has been registered (S10).

If the matched face of the person is the face of the person registered in the VIP list (Yes in S10), feature amount detection unit 23 provides an instruction for filter processing to image correction unit 27. Image correction unit 27 decreases a resolution of the decoded image in the filter processing, for example (S11). A method of reducing the resolution includes a method of reducing the number of display pixels and a method of performing filtering processing by using a Low Pass Filter (LPF).

If the matched face of the person is not the face of the person registered in the VIP list (No in S10), image correction unit 27 sends the decoded image to image synthesizing unit 25 and feature amount detection unit 23 without performing image correction thereon.

According to the processing shown in FIG. 8A, it is possible to make it difficult to recognize a person who is registered in the VIP list and to protect privacy.

FIG. 8B is a flowchart showing a second operation example of image correction unit 27. FIG. 8B shows an operation example in a case in which a person registered in a black list is detected.

Feature amount detection unit 23 matches a face of a person included in a decoded image with a face of a person registered in advance in a black list, for example, and determines whether or not the face has been registered (S15).

If the matched face of the person is the face of a person registered in the black list (Yes in S15), feature amount detection unit 23 provides an instruction for filter processing to image correction unit 27. Image correction unit 27 increases a resolution of the decoded image in the filter processing, for example (S16). A method of increasing the resolution includes a method of increasing the number of display pixels and a method of performing high-resolution filter processing.

If the matched face of the person is not the face of the person registered in the black list (No in S15), image correction unit 27 sends the decoded image to image synthesizing unit 25 and feature amount detection unit 23 without performing image correction thereon.

According to the processing shown in FIG. 8B, it is possible to easily determine a person who is registered in the black list and to ensure security.

Although the example in which a resolution of a decoded image is changed in accordance with a face of a person in this exemplary embodiment, the present invention is not limited thereto. For example, output image configuration unit 24 may adjust a continuous display time of the decoded image so as to display a decoded image, which includes a person registered in the black list, for a long period of time. For example, output image configuration unit 24 may adjust a continuous display time of a decoded image so as to display a decoded image, which includes a person registered in the VIP list, for a short period of time.

Although the example in which the high-resolution filter processing is performed for the face of a person registered in the black list in this exemplary embodiment, the present invention is not limited thereto. For example, image correction unit 27 may perform the high-resolution filter processing (corresponding to the processing in S16 in FIG. 8B, for example) based on the fact that image correction using a high-quality filter is set to be possible.

According to image switching apparatus 20B, it is possible to balance both improvement in security and protection of privacy by feature amount detection unit 23 matching faces and by image correction unit 27 performing image correction.

### Third Exemplary Embodiment

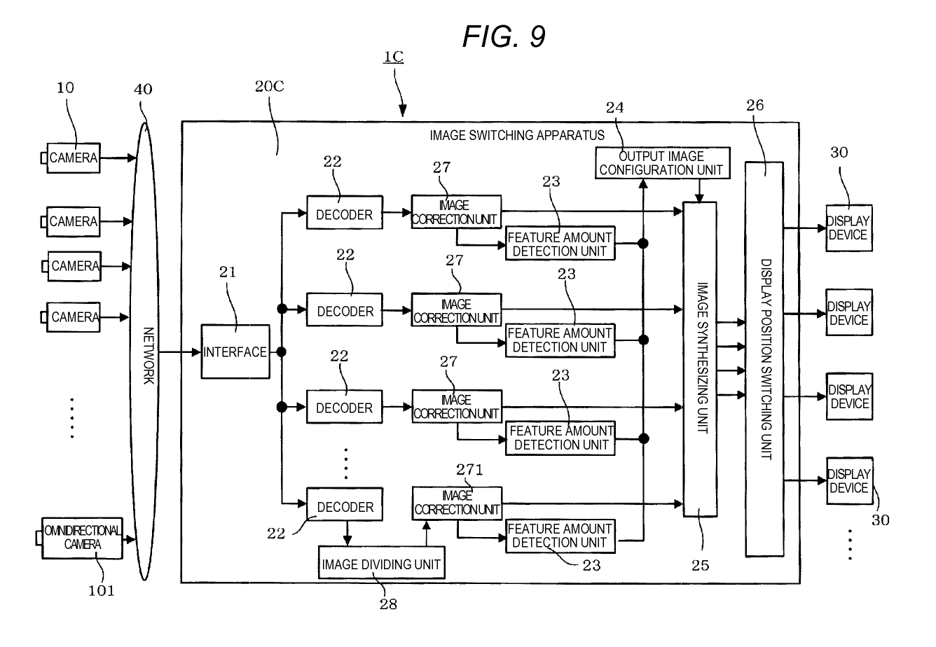

FIG. 9 is a block diagram showing a configuration example of image switching system 1C according to a third exemplary embodiment. Image switching system 1C includes imaging device 10, omnidirectional camera 101, image switching apparatus 20C, and display device 30. In image switching system 1C in FIG. 9, the same reference numerals are given to the same configurations as those in image switching systems 1 and 1B, and the descriptions will be omitted or briefly given. Imaging device 10 other than omnidirectional camera 101 may not be provided.

Image switching apparatus 20C in FIG. 9 includes image dividing unit 28 and image correction unit 271 unlike image switching apparatuses 20 and 20B. Image correction unit 27 may not be provided.

One or more omnidirectional cameras 101 are provided, use fish-eye lenses which are a kind of wide lens as imaging lenses, and can capture an omnidirectional image of 360°. Omnidirectional camera 101 is an example of imaging device 10. A plurality of omnidirectional cameras 101 may be provided.

Decoder 22 decodes an image captured by omnidirectional camera 101 and derives a decoded image (fish-eye decoded image). Image dividing unit 28 divides the fish-eye decoded image into a plurality of decoded images (images divided into four sections of 90° each). Image correction unit 271 performs distortion correction on distortion, which is caused during imaging by the fish-eye lens, in the divided decoded images. Image correction unit 271 is an example of the second image correction unit. Image correction unit 271 may be provided with a function of image correction unit 27. A plurality of image correction units 271 may be provided.

Next, a description will be given of operation examples of image dividing unit 28 and image correction unit 271.

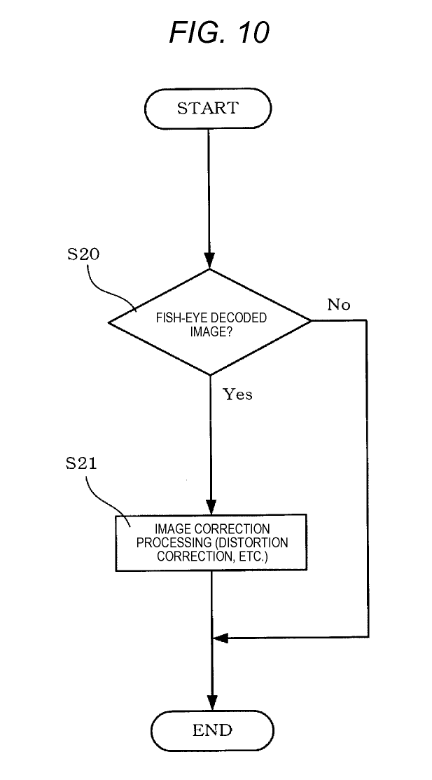

FIG. 10 is a flowchart showing operation examples of image dividing unit 28 and image correction unit 271.

Image dividing unit 28 determines whether or not the decoded image that is decoded by decoder 22 is a fish-eye decoded image that is captured by using a fish-eye lens (S20). The determination of whether or not the decoded image is a fish-eye decoded image is made based on identification information of imaging device 10 (omnidirectional camera 101) as a transmission source of the image, for example.

In the case of a fish-eye stream (Yes in S20), image dividing unit 28 divides the fish-eye decoded image into a plurality of (four, for example) decoded images. Image correction unit 271 performs distortion correction in accordance with distortion abbreviation of the fish-eye lens, for example, on the divided decoded image.

In contrast, if the decoded image is not a fish-eye decoded image (No in S20), image dividing unit 28 and image correction unit 271 send the decoded image to image synthesizing unit 25 and feature amount detection unit 23 without dividing the decoded image and performing image processing thereon.

Next, a description will be given of a relationship between an image layout pattern and total sequence switching time T.

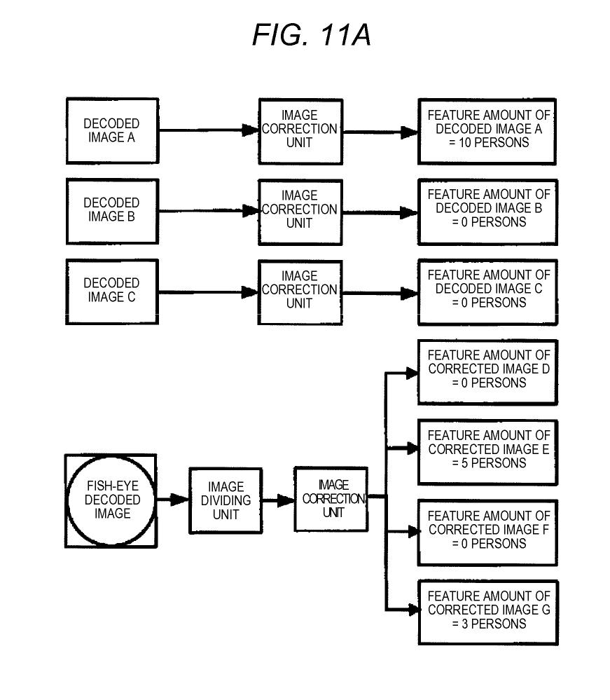

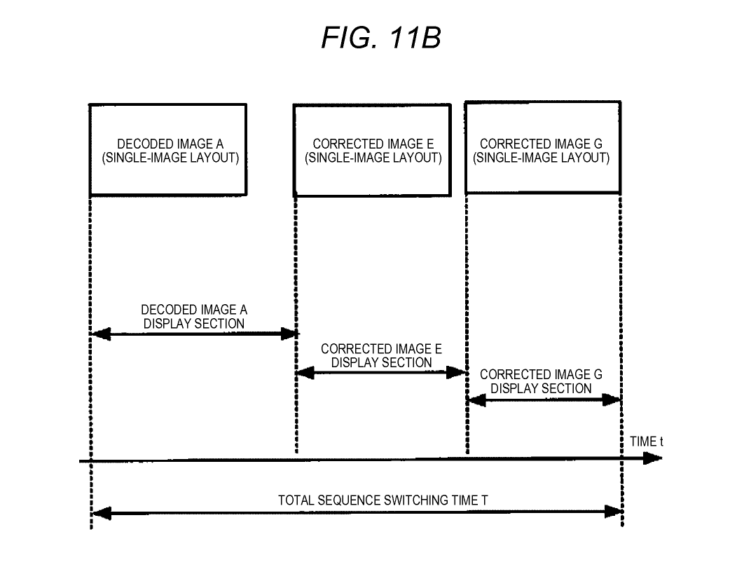

FIGS. 11A and 11B are diagrams schematically showing an example of a relationship between an image layout pattern and total sequence switching time T according to this exemplary embodiment. FIGS. 11A and 11B show an example in which the number of persons included in the decoded image is employed as a feature amount. FIG. 11A shows an exemplary flow until a feature amount of an image is detected from a decoded image or a fish-eye decoded image. FIG. 11B shows an exemplary cycle of a sequence according to the exemplary embodiment.

Decoded images A, B, and C are images captured by ordinary (same as those in the first and second exemplary embodiments) imaging device 10 and decoded. The fish-eye decoded image is an image captured by omnidirectional camera 101 using a fish-eye lens and then decoded. The fish-eye decoded image is divided into four portions, for example, by image dividing unit 28, distortion thereof is corrected by image correction unit 271, and correction images D, E, F, and G after distortion correction are created.

According to this exemplary embodiment, comparison is made in relation to how large the feature amounts of decoded images A, B, and C and corrected images D, E, F, and G are. In FIG. 11A, the feature amount of decoded image A corresponds to ten persons, the feature amount of corrected image E corresponds to five persons, and the feature amount of corrected image G corresponds to three persons in an order from the largest number of persons as feature amounts to the smallest. For this reason, output image configuration unit 24 sets the longest display section for decoded image A, the second longest display section for corrected image E, and the shortest display section for corrected image G as lengths of the respective display sections in total sequence switching time T.

Since (the number of camera images as targets of sequence display×the minimum display time)<total sequence switching time T in FIGS. 11A and 11B, output image configuration unit 24 designates a single-image layout as an image layout pattern.

By installing omnidirectional camera 101 at the center of an area as a target of monitoring, for example, the person who is in charge of monitoring can monitor the flow of people in the respective areas divided from the area as the target of monitoring, with a single camera. In such a case, it is not necessary to prepare four imaging devices 10 and it is possible to thereby achieve a decrease in costs.

According to image switching apparatus 20C, it is possible to derive an image layout pattern and a continuous display time of the respective images in accordance with feature amounts of the images even if the images are captured by omnidirectional camera 101 including a fish-eye lens. Therefore, even if a single omnidirectional camera 101 is provided and other imaging devices 10 are not provided, for example, it is possible to divide an omnidirectional image and to observe a characteristic event in each area. By performing the distortion correction on decoded images obtained by dividing an omnidirectional image, accuracy of detecting feature amounts can be enhanced. Therefore, it is possible to improve utilization efficiency of features of images in switching image display even when omnidirectional camera 101 is used.

The arrangement positions of image dividing unit 28 and image correction unit 271 shown in FIG. 9 are arbitrarily set positions, and the present invention is not limited to the arrangement positions shown in FIG. 9.

### Fourth Exemplary Embodiment

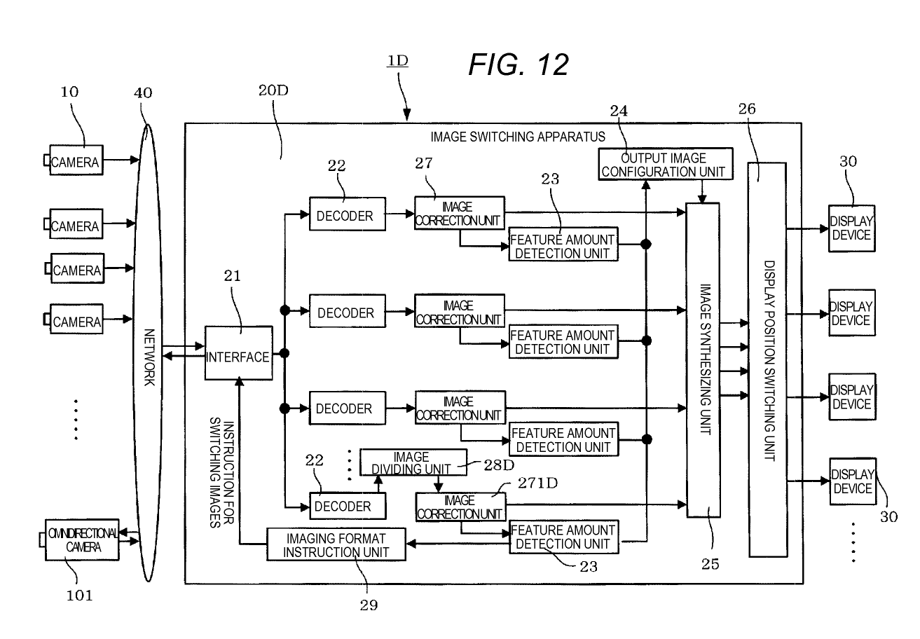

FIG. 12 is a block diagram showing a configuration example of image switching system 1D according to a fourth exemplary embodiment. Image switching system 1D includes imaging device 10, omnidirectional camera 101D, image switching apparatus 20D, and display device 30. In image switching system 1D in FIG. 12, the same reference numerals are given to the same configurations as those in image switching system 1C in FIG. 9, and the description thereof will be omitted or briefly given. Imaging device 10 other than omnidirectional camera 101D may not be provided.

Image switching apparatus 20D in FIG. 12 includes image correction unit 271D and image dividing unit 28D unlike image switching apparatuses 20, 20B, and 20C. Image correction unit 271D performs the same operation as that of image correction unit 271 in an omnidirectional image mode as will be described later. Image dividing unit 28 performs the same operation as that of image dividing unit 28D in the omnidirectional image mode as will be described later. Image correction unit 27 may not be provided.

Although omnidirectional camera 101 acquires an omnidirectional image of 360° in the third exemplary embodiment, omnidirectional camera 101D can capture a Double Panorama (DP) as well as the omnidirectional image in the fourth exemplary embodiment. Whether the omnidirectional camera 101D captures an omnidirectional image or a DP image is determined in response to an input operation by a user via an operation unit (not shown) or an instruction for image switching from image switching apparatus 20, for example. A plurality of omnidirectional cameras 101D may be provided. In image switching system 1D, omnidirectional camera 101D and omnidirectional camera 101 according to the third exemplary embodiment may be provided together.

Imaging format instruction unit 29 sends an instruction for image switching to omnidirectional camera 101D if a feature amount detected from a decoded image or decoded sound satisfies a predetermined reference feature. The instruction for image switching is transmitted from imaging format instruction unit 29 to omnidirectional camera 101D via interface 21 and network 40, for example. The instruction for image switching is an instruction signal for switching a format of imaging through omnidirectional camera 101D. The format of imaging includes an omnidirectional image mode for capturing an omnidirectional image and a DP image mode for capturing a DP image, for example.

Image format instruction unit 29 transmits the instruction for image switching to omnidirectional camera 101 in a case in which the number of persons included in a fish-eye decoded image detected by feature amount detection unit 23 changes from a number that is less than a predetermined number (ten, for example) to a number that is equal to or greater than the predetermined number. In such a case, the instruction for image switching includes an instruction for changing the imaging format from the omnidirectional image mode to the DP image mode. In so doing, it is possible to check a person and the like in an image including a wider area.

Imaging format instruction unit 29 sends an instruction for image switching to omnidirectional camera 101 in a case in which the number of persons included in a DP decoded image that is detected by feature amount detection unit 23 changes from a number that is equal to or greater than a predetermined number to a number that is less than the predetermined number, for example. In such a case, the instruction for image switching includes an instruction for changing the imaging format from the DP image mode to the omnidirectional image mode. In so doing, it is possible to check a person and the like in an image which includes areas divided into smaller sections (four divided areas, for example).

If decoder 22 acquires a DP image in the DP image mode, image dividing unit 28 and image correction unit 271 send the DP decoded image to image synthesizing unit 25 and feature amount detection unit 23 without dividing the DP decoded image and performing image processing thereon.

Omnidirectional camera 101D is provided with a distortion correction function for a DP image. In a case of capturing a DP image, omnidirectional camera 101D corrects distortion therein and sends the DP image to image switching apparatus 20D.

Next, a description will be given of a relationship between an image layout pattern and total sequence switching time T.

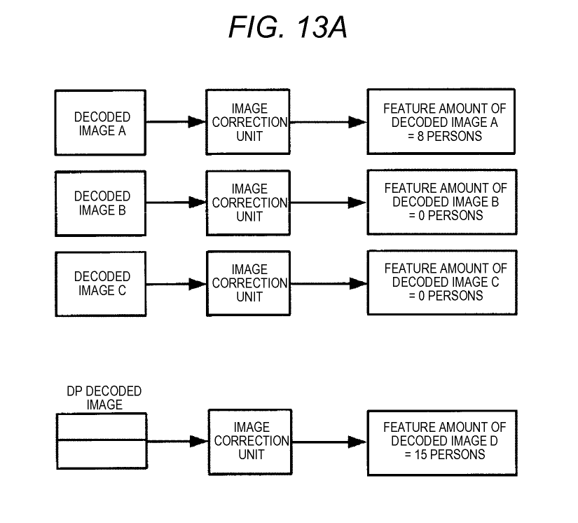

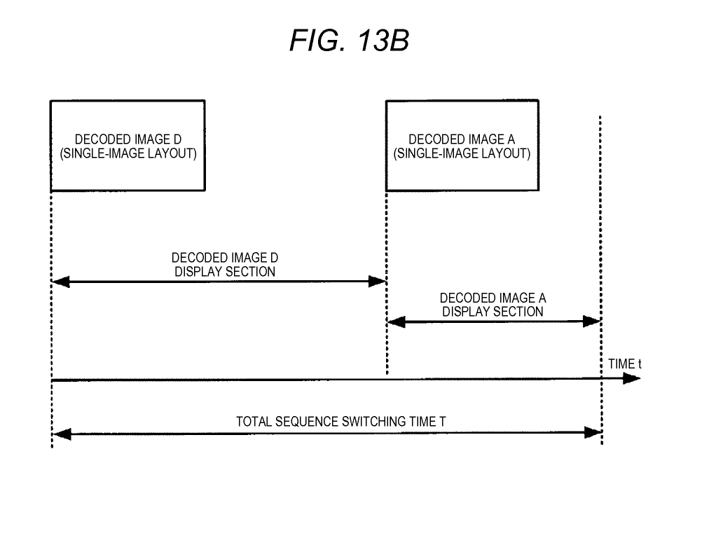

FIGS. 13A and 13B are diagrams schematically showing a relationship between an image layout pattern and total sequence switching time T according to this exemplary embodiment. FIGS. 13A and 13B show an example in which the number of persons included in an image is employed as a feature amount. FIG. 13A shows an exemplary flow until a feature amount of an image is detected from a decoded image, a fish-eye decoded image, or a DP decoded image. FIG. 11B shows an exemplary cycle of a sequence according to this exemplary embodiment.

Decoded images A, B, and C are images captured by ordinary (the same as those in the first and second exemplary embodiments) imaging device 10 and decoded. The DP decoded image is a DP image captured by omnidirectional camera 101D in the DP image mode. The DP image includes two images obtained by dividing an omnidirectional image using omnidirectional camera 101D.

In FIG. 13A, the feature amount of DP decoded image D corresponds to fifteen persons, and the feature amount of decoded image A corresponds to eight persons in the order from the largest number of persons as a feature amount to the smallest. For this reason, output image configuration unit 24 sets a long display section for DP decoded image D and a short display section for decoded image A as lengths of the respective display sections in total sequence switching time T. The feature amount of the DP decoded image is a sum of feature amounts of both of the two divided images (the aligned upper and lower images in FIG. 13A).

Since (the number of camera images as targets of sequence display×the minimum display time)<total sequence switching time T in FIGS. 13A and 13B, output image configuration unit 24 designates the single-image layout as an image layout pattern.

Although decoded image D is shown in the single-image layout in FIGS. 13A and 13B, this means that two images of 180° are displayed on one screen displayed on display device 30.

Imaging format instruction unit 29 may send an instruction for image switching to omnidirectional camera 101D in accordance with a feature amount of data other than the number of persons. For example, imaging format instruction unit 29 may send the instruction for image switching to omnidirectional camera 101D if feature amount detection unit 23 detects a person or if the face of a person registered in the VIP list or the black list is detected from a decoded image.

According to image switching apparatus 20D, it is possible to facilitate checking of the flow and motion of persons in a predetermined area and to thereby improving marketing efficiency and monitoring efficiency by changing the imaging format of omnidirectional camera 101D in accordance with variations in feature amounts, for example.

The image switching apparatus, the image switching system, and the image switching method according to the aforementioned exemplary embodiments can be used in a store, a hotel, an office, or a public facility, for example. The image switching apparatus, the image switching system, and the image switching method are applied for the purpose of improving efficiency in marketing, monitoring, or crime prevention.

The image switching apparatus includes a monitoring recorder, for example. The image switching system includes a monitoring system, for example.

The present invention is not limited to the aforementioned exemplary embodiments, and modifications, amendments, and the like can be appropriately made thereto. In addition, materials, shapes, dimensions, numerical values, configurations, numbers, arrangement positions, and the like of the respective constituents in the aforementioned exemplary embodiments may be arbitrarily set as long as the present invention can be achieved, and are not limited.

Although the example in which image data coded by the imaging device is received was described in the aforementioned exemplary embodiments, an analog video signal may be received. In such a case, decoder 22 may not be provided.

What is claimed is:

1. An image switching apparatus comprising:
a data acquisition unit configured to acquire data that includes images captured by imaging devices;
a feature amount detection unit configured to detect feature amounts of the acquired data;
a designation unit configured to designate a continuous display time in a case of displaying the images corresponding to the data, the feature amounts of which are detected, on a display device based on the feature amounts of the data; and
an image display control unit configured to switch and display the respective images on the display device for each designated continuous display time.

2. The image switching apparatus of claim 1,
wherein the designation unit designates a display position of the respective images on the display device and the continuous display time of the respective images based on the number of images corresponding to the data, the feature amounts of which are detected by the feature amount detection unit, a minimum display time for displaying the images corresponding to the data, the feature amounts of which are detected, and an image switching cycle indicating a cycle by which the images are switched and displayed, and
wherein the image display control unit switches and displays the respective images on the display device based on the designated display positions and the continuous display time of the respective images.

3. The image switching apparatus of claim 1, further comprising:
a first image correction unit configured to correct the images based on the feature amounts of the data,
wherein the image display control unit displays the corrected images on the display device.

4. The image switching apparatus of claim 1,
wherein the data acquisition unit acquires data including a plurality of images that are captured by a plurality of imaging devices.

5. The image switching apparatus of claim 1, further comprising:
an image dividing unit configured to divide the images,
wherein the data acquisition unit acquires data including an omnidirectional image that is captured by the imaging devices,
wherein the image dividing unit divides the omnidirectional image, and
wherein the feature amount detection unit detects a feature amount from each of the divided images.

6. The image switching apparatus of claim 5, further comprising:
a second image correction unit configured to correct distortion of the plurality of divided images,
wherein the feature amount detection unit detects feature amounts of the images after correcting the distortion.

7. The image switching apparatus of claim 6, further comprising:
an imaging format instruction unit configured to provide an instruction to change an imaging format of the imaging devices to the imaging devices that capture images corresponding to the images, as targets of the distortion correction, in accordance with the feature amounts of the data.

8. The image switching apparatus of claim 1,
wherein the feature amounts of the data include the number of persons in the images, the presence or absence of motion, the amount of movement, the number of detected faces, or the presence or absence of a predetermined face.

9. The image switching apparatus of claim 1,
wherein the data acquisition unit acquires data including sound data collected by the imaging devices, and
wherein the feature amounts of the data include the presence or absence of abnormal sound included in the sound data, the presence or absence of a predetermined keyword, or the presence or absence of sound that is equal to or greater than a predetermined signal level.

10. An image switching system in which an imaging device, a display device, and an image switching apparatus are connected via a network,
wherein the imaging device includes an imaging unit configured to capture images and a first communication unit configured to transmit data including the captured images,
wherein the image switching apparatus includes a second communication unit configured to receive the data from the imaging device, a feature amount detection unit configured to detect feature amounts of the received data, a designation unit configured to designate a continuous display time in a case of displaying the images corresponding to data, the feature amounts of which are detected, on the display device based on the feature amounts of the data, and an image display control unit configured to switch and display the respective images on the display device for each designated continuous display time,
wherein the second communication unit transmits, to the display device, the images and control data for switching and displaying the respective images on the display device for each designated continuous display time, and
wherein the display device includes a third communication unit configured to receive the images and the control data and a display unit configured to switch and display the respective images for each designated continuous display time based on the control data.

11. An image switching method for an image switching apparatus, the method comprising:
acquiring data including images that are captured by an imaging device;
detecting feature amounts of the acquired data;
designating a continuous display time in a case of displaying the images corresponding to the data, the feature amounts of which are detected, on a display device based on the feature amounts of the data; and
switching and displaying the respective images on the display device for each designated continuous display time.
